(19) United States
(12) Patent Application Publication
(10) Pub. No.: US 2011/0227801 A1
(43) Pub. Date: Sep. 22, 2011

(54) HIGH ISOLATION MULTI-BAND ANTENNA SET INCORPORATED WITH WIRELESS FIDELITY ANTENNAS AND WORLDWIDE INTEROPERABILITY FOR MICROWAVE ACCESS ANTENNAS

(76) Inventor: Hsu-Sheng Wu, Changhua County (TW)

(21) Appl. No.: 12/861,846

(22) Filed: Aug. 24, 2010

(30) Foreign Application Priority Data
Mar. 22, 2010 (TW) 099108325

(51) Int. Cl. H01Q 21/28

(52) U.S. Cl. 343/725

(57) ABSTRACT

A high isolation multi-band antenna includes a housing, at least one WiMAX antenna array installed inside the housing, at least one Wi-Fi antenna installed inside the housing, and a printed circuit board installed inside the housing for processing signals accessed through the at least one WiMAX antenna and the at least one Wi-Fi antenna. The at least one Wi-Fi antenna is substantially orthogonal to the at least one WiMAX antenna.

### BACKGROUND OF THE INVENTION

1. Field of the Invention

The present invention relates to a high isolation, multi-band antenna set, and more particularly, to a high isolation, multi-band antenna set incorporated with wireless fidelity antennas and worldwide interoperability for microwave access antennas.

2. Description of the Prior Art

Recently, due to rapid advances in wireless communication technologies, electronic products, such as mobile phones, notebook computers, and personal digital assistants (PDAs) may access signals through antennas. So a user may use the electronic products to exchange data, browse websites, and send/receive e-mail via a wireless wide area network (WWAN).

In different wireless communication systems, operating frequencies of various wireless communication networks are different. For example, the operating frequency of a wireless fidelity (Wi-Fi) system is about 2.4 GHz-2.5 GHz, the operating frequency of a worldwide interoperability for microwave access (WiMAX) system is about 2.3 GHz-2.7 GHz, the operating frequency of a wideband code division multiple access (CDMA) system is about 1850 MHz-2025 MHz, and the operating frequency of a global system for mobile (GSM) communications system is about 1850 MHz-1990 MHz. Therefore, dual-band or multi-band antennas are provided for users who desire to access various wireless communication networks easily.

“Improved structure of multi-frequency array antenna” is disclosed in Taiwan Patent Publication No. 562253. The multi-band array antenna uses an insulating substrate as a body, and layouts of the multi-band array antenna are disposed on a front side and a back side of the insulating substrate. The front layout of the multi-band array antenna comprises a center circuit disposed on a center line of the insulating substrate. A pair of branch circuits extends symmetrically from the center circuit. An end of each branch circuit parallels both edges of the insulating substrate and extends upward like an arm. A circuit array comprises a plurality of the branch circuits. The arms and bases of the branch circuits on the circuit arrays located on both sides of the insulating substrate include independent copper foil areas and a coil. Capacitor effects are generated between the independent copper foil areas and the circuit arrays, and the coil has an inductor effect. LC oscillation is generated through the capacitors and the inductor for receiving and transmitting signals of a plurality of frequencies (2.4 GHz, 5.2 GHz, and 5.8 GHz). However, the improved structure for multi-band array antennas has a disadvantage of low gain.

In addition, the prior art does not usually provide a WiMAX antenna array having optimal gain in a limited space, and a pattern of the Wi-Fi antenna is also not proper, leading to poor isolation between the WiMAX antenna array and the Wi-Fi antenna when the two antennas coexist. The WiMAX antenna array designed according to the prior art also may not achieve optimal gain and pattern, and due to leaky waves from a power divider of the WiMAX antenna array, the isolation between the WiMAX antenna array and the Wi-Fi antenna is poor when the two antennas coexist.

### SUMMARY OF THE INVENTION

An embodiment of the present invention provides a high isolation and multiple-band antenna set incorporated with Wi-Fi antenna and WiMAX antenna. The high isolation and multiple-band antenna set comprises a housing, at least one WiMAX antenna, at least one Wi-Fi antenna, and a first printed circuit board. The at least one WiMAX antenna is installed inside the housing. The at least one Wi-Fi antenna is installed inside the housing, and the at least one Wi-Fi antenna is substantially orthogonal to the at least one WiMAX antenna. The first printed circuit board is installed inside the housing for processing signals accessed through the at least one WiMAX antenna and the at least one Wi-Fi antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a high isolation and multiple-band antenna set incorporated with Wi-Fi antennas and WiMAX antennas.

FIG. 2 is a diagram illustrating a perspective of the high isolation and multiple-band antenna set in the x direction.

FIG. 3 is a diagram illustrating a perspective of the high isolation and multiple-band antenna set in the y direction.

FIG. 4 is a diagram illustrating the WiMAX antenna array.

FIG. 5 is a diagram illustrating the Wi-Fi antenna and the second substrate.

### DETAILED DESCRIPTION

A frequency band of WiMAX signals is in a range of 2.3 GHz-2.7 GHz, and a frequency band of Wi-Fi signals is in a range of 2.4-2.5 GHz. Therefore, a multi-band antenna set incorporated with a Wi-Fi antenna and a WiMAX antenna may operate in both ranges (2.3-2.7 GHz and 2.4-2.5 GHz) without the Wi-Fi antenna and the WiMAX antenna interfering with each other. Polarization current of the Wi-Fi antenna is orthogonal to polarization current of the WiMAX antenna array, so as to prevent the Wi-Fi antenna and the WiMAX antenna array from interfering with each other, and to achieve high isolation.

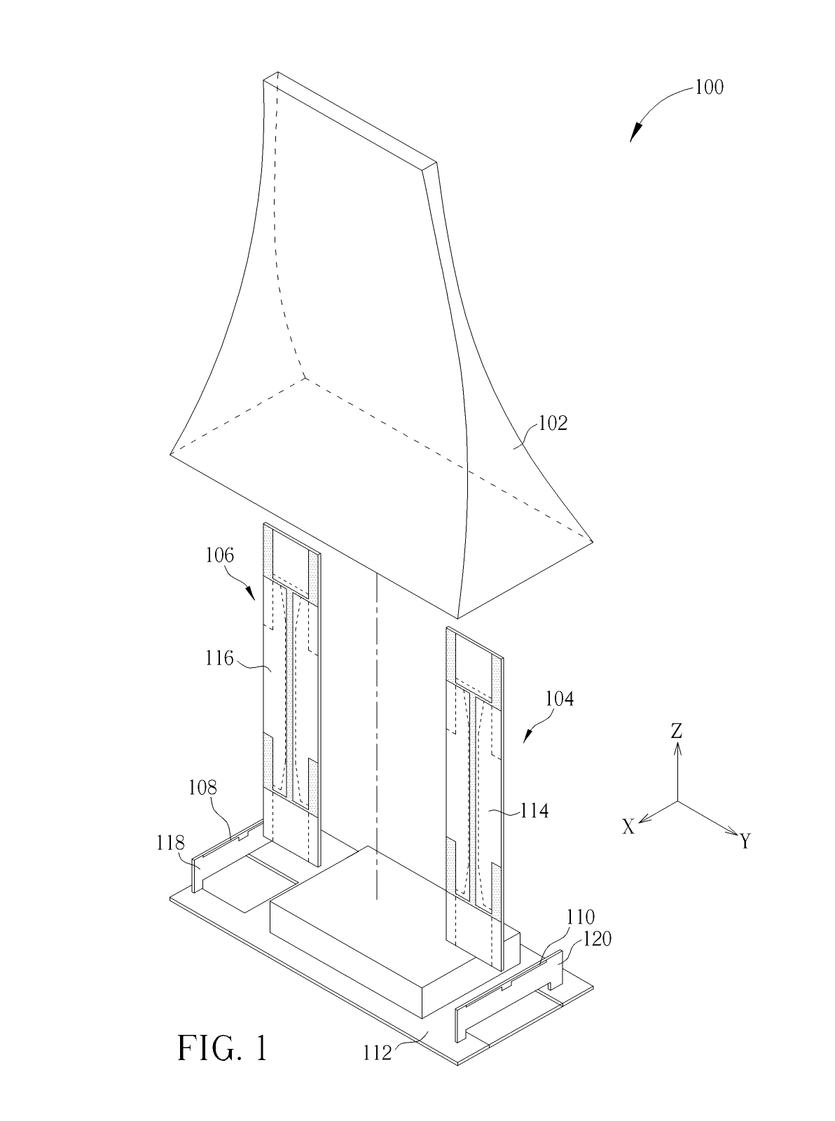

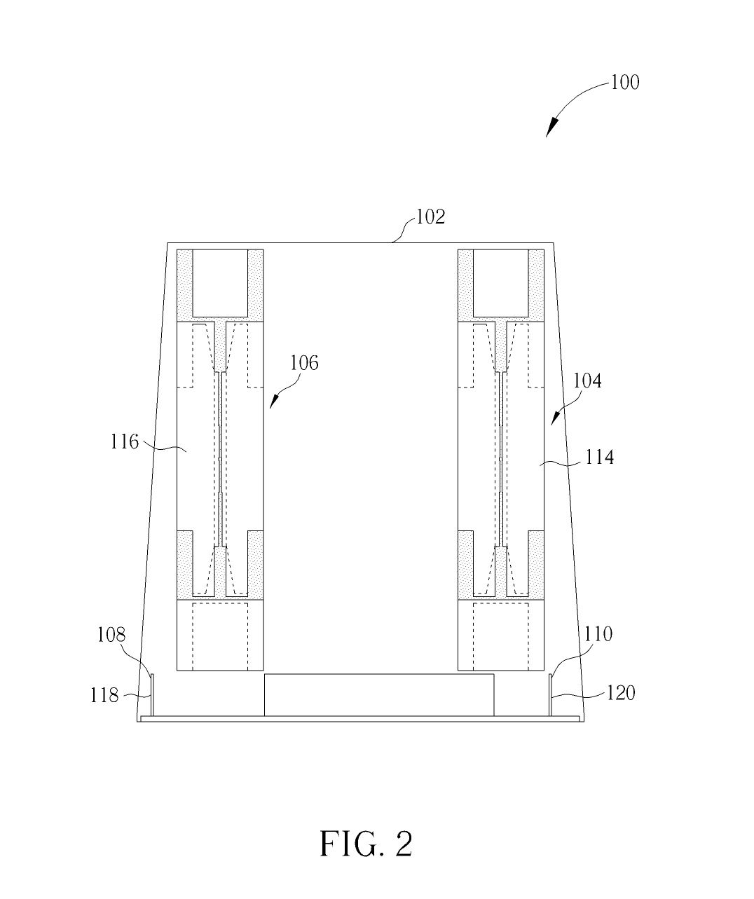

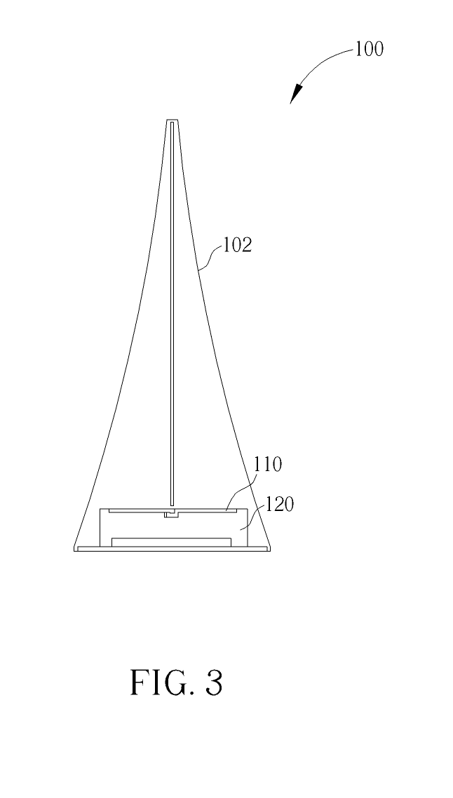

Please refer to FIG. 1 to FIG. 3. FIG. 1 is a diagram illustrating a high isolation multi-band antenna set 100 incorporated with Wi-Fi antennas and WiMAX antennas. FIG. 2 is a diagram illustrating a perspective of the high isolation multi-band antenna set 100 in the x direction. FIG. 3 is a diagram illustrating a perspective of the high isolation multi-band antenna set 100 in the y direction. The high isolation multi-band antenna set 100 comprises a housing 102, two WiMAX antenna arrays 104, 106, two Wi-Fi antennas 108, 110, a first printed circuit board 112, two first substrates 114, 116, and two second substrates 118, 120. The WiMAX antenna array 104 is installed on the first substrate 114 inside the housing 102, and the WiMAX antenna array 106 is installed on the first substrate 116 inside the housing 102, where the WiMAX antenna arrays 104, 106 are used for accessing the WiMAX signals, and the first substrate 114 and the first substrate 116 are both electrically connected to the first printed circuit board 112. The Wi-Fi antenna 108 is installed on the second substrate 118 inside the housing 102, and the Wi-Fi antenna 110 is installed on the second substrate 120 inside the housing 102, wherein the Wi-Fi antenna 108 and the Wi-Fi antenna 110 are used for accessing the Wi-Fi signals, and the second substrate 118 and the second substrate 120 are both disposed on the first printed circuit board 112 and electrically connected to the first printed circuit board 112. The first printed circuit board 112 is installed inside the housing 102 for processing the signals accessed through the WiMAX antenna 104, 106 and the Wi-Fi antenna 108, 110.

As shown in FIG. 1, antenna layouts of the Wi-Fi antennas 108, 110 are disposed in an xz plane, and directions of the polarization currents of the Wi-Fi antennas 108, 110 are in the x direction. The WiMAX antennas array 104, 106 comprise power dividers and a plurality of antenna radiation devices. Antenna layouts of the power dividers and the plurality of antenna radiation devices are both disposed in a yz plane, thus leaky waves of the power dividers may be limited in the yz plane, and directions of the polarization currents of the plurality of antenna radiation devices are in a z direction. That is to say, the polarization currents of the Wi-Fi antennas 108, 110 are substantially orthogonal to the polarization currents of the power dividers and the plurality of antenna radiation devices of the WiMAX antenna arrays 104, 106, but the present invention is not limited to the above layout methods. Any configuration in which the polarization currents of the Wi-Fi antennas 108, 110 are substantially orthogonal to the polarization currents of the WiMAX antenna arrays 104, 106 falls within the scope of the present invention. Because the polarization currents of the Wi-Fi antennas 108, 110 are substantially orthogonal to the polarization currents of the WiMAX antenna arrays 104, 106, the WiMAX antenna arrays 104, 106 and the Wi-Fi antennas 108, 110 may maintain good communication quality, respectively, and achieve high isolation effect.

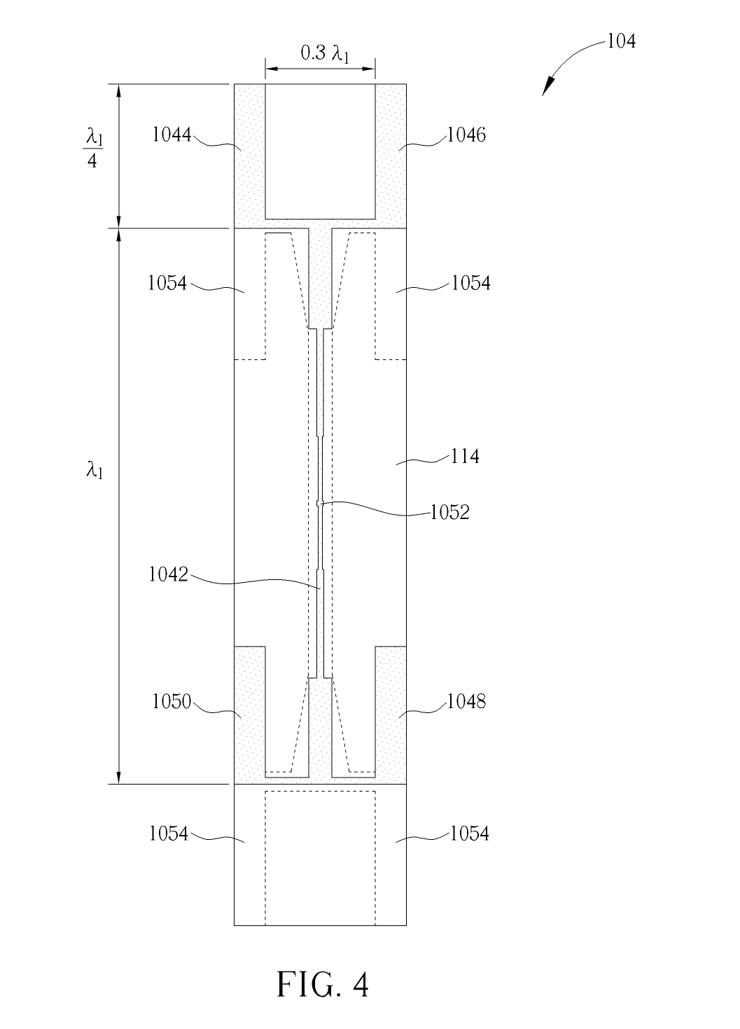

Please refer to FIG. 4. FIG. 4 is a diagram illustrating the WiMAX antenna array 104. Because a structure of the WiMAX antenna array 106 is the same as the structure of the WiMAX antenna array 104, FIG. 4 only illustrates the WiMAX antenna array 104, and the WiMAX antenna array 106 is omitted for simplicity. The WiMAX antenna array 104 comprises a power divider 1042, a plurality of microstrip line antenna radiation devices 1044-1050, an input signal point 1052, and a ground radiation device 1054. The ground radiation device 1054 corresponds to the plurality of microstrip line antenna radiation devices 1044-1050, and may work together with the plurality of microstrip line antenna radiation devices 1044-1050 as an antenna radiation body. The WiMAX antenna array 104 is installed on the first substrate 114, and has a dual-sided structure. The plurality of microstrip line antenna radiation devices 1044-1050 and the power divider 1042 are installed on the front side of the first substrate 114, and the ground radiation device 1054 is installed on the back side of the first substrate 114. Considering both the leaky wave control and the design of antenna array power divider, it is easier to carry out by the microstrip structure than a coplanar waveguide structure, and the WiMAX antenna array 104 can transmit/receive the WiMAX signals at the same time and achieve higher gain. Because the signals of the WiMAX are transmitted from outdoor base stations, the signals may suffer severe attenuation as the signals travel to the WiMAX antenna array 104. Therefore, the WiMAX antenna needs higher gain. In addition, a material of the first substrate 114 may be a dielectric, a ceramic, a glass, a magnetic material, a polymer, or a combination thereof.

Please refer to FIG. 2 and FIG. 4. A length of each of the microstrip antenna radiation devices 1044-1050 and a length of the ground radiation device 1054 are substantially ¼ wavelength

$$( \frac{{λ}_{1}}{4} )$$

of the signals accessed through the WiMAX antenna array 104. And, the length of each of the microstrip antenna radiation devices 1044-1050 and the length of the ground radiation device 1054 may decrease slightly with increased dielectric constant of the first substrate 114. A distance between each two adjacent antenna radiation devices of the microstrip antenna radiation devices 1044-1050 in the vertical direction is substantially the wavelength (λ₁) of the signals accessed through the WiMAX antenna array 104. A distance between centers of the microstrip antenna radiation devices 1044 and 1046 is substantially 0.1 to 0.3 times

$$( \frac{1 {λ}_{1}}{10} to \frac{3 {λ}_{1}}{10} )$$

the wavelength of the signals accessed through the WiMAX antenna array 104. A distance between two centers of the WiMAX antenna arrays 104 and 106 is substantially at least n/4 times

$$( \frac{( n + 1 ) {λ}_{1}}{4} )$$

the wavelength of the signals accessed through the WiMAX antenna array 104. When n is an integer larger than one, an isolation between the WiMAX antenna arrays 104 and 106 may be lower than −10 dB. However, the present invention is not limited to the above size of the WiMAX antenna array 104. Any multi-band antenna set incorporated with the Wi-Fi antennas and the WiMAX antennas falls within the scope of the present invention.

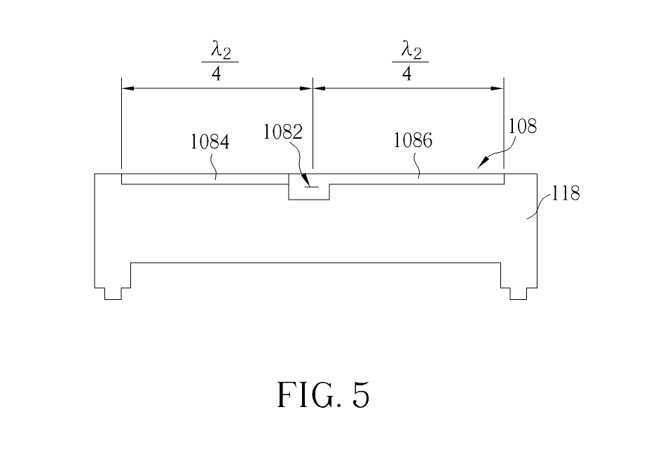

Please refer to FIG. 5. FIG. 5 is a diagram illustrating the Wi-Fi antenna 108 and the second substrate 118. Because the structure of the Wi-Fi antenna 108 is the same as the structure of the Wi-Fi antenna 110, FIG. 5 only illustrates the Wi-Fi antenna 108 and the Wi-Fi antenna 110 is omitted for simplicity. The Wi-Fi antenna 108 is installed on the second substrate 118, and has a dual-sided structure similar to that of the WiMAX antenna array 104. FIG. 5 is a diagram illustrating a front side of the Wi-Fi antenna 108 and the second substrate 118. As shown in FIG. 5, the Wi-Fi antenna 108 is a dipole antenna, but the present invention is not limited to the dipole antenna; the Wi-Fi antenna 108 may be a mono-pole antenna or any single linear-polarization antenna. A length of the Wi-Fi antenna 108 (comprising a microstrip antenna radiation device 1084 and a ground radiation device 1086 corresponded to the microstrip antenna radiation device 1084) is substantially ½ wavelength

$$( \frac{{λ}_{2}}{2} )$$

of the signals accessed through the Wi-Fi antenna 108, and the length of the Wi-Fi antenna 108 may decrease slightly with increased dielectric constant of the second substrate 118. The Wi-Fi signals are inputted through the input point 1082. The ground radiation device 1086 is a ground terminal of the antenna radiation device 1084, and has a function of a radiation device. Because the signals accessed through the Wi-Fi antenna 108 are indoor signals, the Wi-Fi antenna 108 does not form an array structure the same as the WiMAX antenna array 104 to boost its gain. In addition, a material of the second substrate 118 may be a dielectric, a ceramics, a glass, a magnetic material, a polymer, or a combination thereof. However, the present invention is not limited to the above mentioned lengths of the WiMAX antenna array 104 and the length of the Wi-Fi antenna 108. Any multi-band antenna set incorporated with the Wi-Fi antennas and the WiMAX antennas falls within the scope of the present invention.

The present invention uses the WiMAX antenna array to achieve the high gain performance. In addition, the present invention takes space diversity and polarization diversity into consideration to find a proper position for the Wi-Fi dipole antenna orthogonal to the WiMAX dipole antenna array. Therefore, the high isolation and high gain characteristics of the present invention are better than the prior art. The present invention is not limited to the above layouts of the WiMAX antenna array and the Wi-Fi antenna. Any high isolation multi-band antenna set incorporated with the Wi-Fi antennas and the WiMAX antenna arrays realized through an orthogonal method falls within the scope of the present invention.

Those skilled in the art will readily observe that numerous modifications and alterations of the device and method may be made while retaining the teachings of the invention.

What is claimed is:

1. A high isolation multi-band antenna set incorporated with wireless fidelity (Wi-Fi) antennas and worldwide interoperability for microwave access (WiMAX) antennas, comprising:
a housing;
at least one WiMAX antenna installed inside the housing;
at least one Wi-Fi antenna installed inside the housing substantially orthogonal to the at least one WiMAX antenna; and
a first printed circuit board installed inside the housing for processing signals accessed through the at least one WiMAX antenna and the at least one Wi-Fi antenna.

2. The high isolation multi-band antenna set of claim 1, further comprising:
at least one first substrate installed inside the housing, wherein each WiMAX antenna is installed on a first substrate, and each WiMAX antenna comprises a power divider, and a plurality of antenna radiation devices coupled to the power divider, wherein the plurality of antenna radiation devices are arranged in an array.

3. The high isolation multi-band antenna set of claim 2, further comprising:
at least one second substrate installed inside the housing, wherein each Wi-Fi antenna is installed on a second substrate.

4. The high isolation multi-band antenna set of claim 3, wherein the second substrate is installed on the first printed circuit board.

5. The high isolation multi-band antenna set of claim 2, wherein a length of each antenna radiation device and a length of each ground radiation device are substantially ¼ wavelength of the signals accessed through the WiMAX antenna, and the length of the antenna radiation device
$$\frac{{L}_{1}}{2}$$
and the length of the ground radiation device
$$\frac{{L}_{1}}{2}$$
are determined according to the following equation:
$$\frac{{L}_{1}}{2} = \frac{{λ}_{1}}{4 \sqrt{{ɛ}_{re 1}}} - Δ {I}_{oc 1} ;$$
wherein:
λ₁ represents the wavelength of the signals accessed through the WiMAX antenna;
∈ᵣₑ₁ represents an equivalent dielectric constant between the air and the first substrate; and
ΔI_{oc1} represents an equivalent capacitor of an open circuit of the WiMAX antenna.

6. The high isolation multi-band antenna set of claim 2, wherein a distance between each two adjacent antenna radiation devices of the plurality of antenna radiation devices in the vertical direction is substantially the wavelength of the signals accessed through the WiMAX antenna.

7. The high isolation multi-band antenna set of claim 2, wherein a distance between each two adjacent antenna radiation devices of the plurality of antenna radiation devices in the horizontal direction is substantially 0.1 to 0.3 times the wavelength of the signals accessed through the WiMAX antenna.

8. The high isolation multi-band antenna set of claim 1, further comprising:
at least one second substrate installed inside the housing, wherein each Wi-Fi antenna is installed on a second substrate.

9. The high isolation multi-band antenna set of claim 8, wherein the second substrate is installed on the first printed circuit board.

10. The high isolation multi-band antenna set of claim 1, wherein a distance between centers of each two WiMAX antennas is substantially (n+1)/4 times the wavelength of the signals accessed through the WiMAX antenna, wherein n is a positive integer.

11. The high isolation multi-band antenna set of claim 1, wherein the Wi-Fi antenna is a monopole antenna, a dipole antenna, or any single linear-polarization antenna.

12. The high isolation multi-band antenna set of claim 1, wherein a length of each Wi-Fi antenna is substantially ½ wavelength of signals accessed through the Wi-Fi antenna, and the length of the Wi-Fi antenna L₂ is determined according to the following equation:
$${L}_{2} = \frac{{λ}_{2}}{2 \sqrt{{ɛ}_{re 2}}} - 2 Δ {I}_{oc 2} ;$$
wherein:
L₂ represents a sum of a length of an antenna radiation device and a length of a ground radiation device of the Wi-Fi antenna;
λ₂ represents the wavelength of the signals accessed through the Wi-Fi antenna;
∈ᵣₑ₂ represents an equivalent dielectric constant between the air and the second substrate; and
ΔI_{oc2} represents an equivalent capacitor of an open circuit of the Wi-Fi antenna.
